(19) United States
(12) Patent Application Publication
(10) Pub. No.: US 2006/0193415 A1
(43) Pub. Date: Aug. 31, 2006

(54) Apparatus and method for detecting sync signal

(75) Inventors: Myung-sik Kim, Suwon-si (KR); Hyun-jeong Park, Suwon-si (KR); Joo-seon Kim, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/246,520

(22) Filed: Oct. 11, 2005

(30) Foreign Application Priority Data
Feb. 28, 2005 (KR) 2005-16937

(51) Int. Cl. H04L 7/00

(52) U.S. Cl. 375/368

(57) ABSTRACT

An apparatus and a method of detecting a sync signal, the apparatus including a sync determiner selecting an output sync pattern from a candidate sync signal generated by pattern matching in lock and/or unlock modes and selecting one of candidate sync patterns of the candidate sync signal having a cycle synchronizing with a sync cycle as an output sync pattern to generate an output sync signal; and a mode determiner determining a mode based on the candidate sync signal, a mode conversion threshold value, and a selection number of times the candidate sync pattern is selected as the output sync pattern.

### CROSS-REFERENCE TO RELATED APPLICATION

This application claims the benefit of Korean Patent Application No. 2005-16937, filed on Feb. 28, 2005 in the Korean Intellectual Property Office, the disclosure of which is incorporated herein in its entirety by reference.

### BACKGROUND OF THE INVENTION

1. Field of the Invention

An aspect of the present invention relates to an apparatus and method of detecting a sync signal, and more particularly, to an apparatus and method of detecting a sync signal by which a candidate sync pattern having an interval synchronizing with a sync cycle is selected as an output sync pattern and a mode is determined based on a number of times the output sync pattern is selected so as to improve a lock conversion time and track an accurate sync signal more quickly.

2. Description of the Related Art

FIG. 1 is a block diagram of a conventional sync signal detecting apparatus. Referring to FIG. 1, a sync signal detecting apparatus 100 includes a pattern detector 110, a sync determiner 120, and a mode determiner 130.

The pattern detector 110 performs pattern matching of an input signal 102 to detect a candidate sync signal 112. The candidate sync signal 112 is a clock signal read from a recording medium, i.e., a signal coded according to an NRZI coding method and so on. The pattern matching may be full pattern matching, common pattern matching, or margin pattern matching.

The sync determiner 120 selects one of patterns of the candidate sync signal 112, i.e., one of the candidate sync patterns, or interpolates a pseudo pattern in a detection mode indicated by a mode indication signal 132 to generate an output sync signal 122. A sync pattern of the output sync signal 122 is called an output sync pattern. In other words, a sync pattern or a pseudo pattern is selected as the output sync pattern.

The mode indication signal 132 includes a lock mode signal indicating a lock mode and an unlock mode signal indicating an unlock mode.

In the lock mode, i.e., if the mode indication signal 132 is the lock mode signal, the sync determiner 120 generates a window in a window position indicating a time position in which a sync signal is to be generated, if a candidate sync pattern is generated in the corresponding window, the generated candidate sync pattern is selected as the output sync pattern, and if the candidate sync pattern is not generated in the corresponding window, the sync determiner 120 interpolates a pseudo pattern in the corresponding window position. A size of the window is selected by a user, and a position of the window ranges from a starting point of an output sync pattern detected in a just previous time to a time position after a pattern cycle (588T, 1488T, 1116T, or 1932T in cases of compact disc (CD), a digital versatile disc (DVD), a HD, and a BD, respectively) elapses.

In the unlock mode, i.e., if the mode indication signal 132 is the unlock mode signal, the sync determiner 120 selects a candidate sync pattern as the output sync pattern.

The mode determiner 130 generates the mode indication signal 132 based on the candidate sync signal 112 and a mode conversion threshold value 114. The mode conversion threshold value 114 is selected by the user and includes a lock mode conversion threshold value and an unlock mode conversion threshold value. The mode determiner 130 generates the mode indication signal 132 using the following method.

The mode determiner 130 calculates a window inclusion number Nw indicating a number of times the candidate sync pattern of the candidate sync signal 112 is positioned in the window.

If the window inclusion number Nw is greater than or equal to an unlock mode conversion threshold value N_ul in the lock mode, the mode determiner 130 generates a mode indication signal indicating the unlock mode. In other words, if the window inclusion number Nw is greater than or equal to the unlock mode conversion threshold value N_ul in the lock mode, the mode determiner 130 converts the lock mode into the unlock mode, and then the sync determiner 120 generates the output sync signal 122 in the unlock mode.

If the window inclusion number Nw is greater than or equal to a lock mode conversion threshold value N_l in the unlock mode, the mode determiner 130 generates a mode indication signal indicating the lock mode. In other words, if the window inclusion number Nw is greater than or equal to the lock mode conversion threshold value N_l in the unlock mode, the mode determiner 130 converts the unlock mode into the lock mode, and then the sync determiner 120 generates the output sync signal 122 in the lock mode.

FIG. 2 is a clock diagram illustrating the operation of the sync determiner 120. Referring to FIG. 2, it is assumed that the unlock mode conversion threshold value N_ul is “2,” and the lock mode conversion threshold value N_l is “2.” It is also assumed that the mode indication signal is “1” in the lock mode but “0” in the unlock mode. Time positions among the mode indication signal, a window signal, and the candidate sync signal are synchronized with one another, and time positions between a pseudo pattern and an output sync signal are synchronized with each other. However, time positions of the mode indication signal, the window signal, and the candidate sync signal are not synchronized with the time positions of the pseudo pattern and the output sync signal. This is because a time is required to generate and interpolate the pseudo pattern.

The sync determiner 120 generates an output sync signal in a section between times to and t₁ in the lock mode. Since no candidate sync pattern is generated in a window W1, the sync determiner 120 generates a pseudo pattern 222 in a time position corresponding to the window W1 and selects the pseudo pattern 222 as an output sync pattern 232. Also, since no candidate sync pattern is generated in a window W2, the sync determiner 120 generates a pseudo pattern 224 in a time position corresponding to the window W2 and selects the pseudo pattern 224 as an output sync pattern 234. Since the window inclusion number Nw is “2” (≧the unlock mode conversion threshold value N_ul) at the time t₁, the lock mode is converted into the unlock mode.

The sync determiner 120 generates an output sync signal in a section between times t₁ and t₂ in the unlock mode. In other words, the sync determiner 120 selects candidate sync patterns 214 and 216 as output sync patterns 236 and 238. Since the window inclusion number Nw is “2” (≧the lock mode conversion threshold value N_l) at the time t₂, the unlock mode is converted into the lock mode.

However, in such a conventional sync detecting apparatus, a large amount of time is required to track an accurate sync position depending on lock and unlock mode conversion threshold values selected by a user.

Also, if one frame interval is not uniform due to a non-uniform control of a spindle during reading of a radio frequency (RF) signal from a recording medium, a candidate sync pattern is not detected in a position in which a sync signal is to be detected, i.e., in a window in a conventional sync detecting apparatus. Thus, a pseudo pattern is interpolated. However, correction is not performed in a position in which the pseudo pattern is interpolated, which causes a symbol error rate (SER) to increase. In other words, the position in which the pseudo pattern is interpolated depends on a position of a window of a past output sync pattern. If an error occurs in the position of the past output sync pattern, the SER increases during demodulation due to the interpolation.

### SUMMARY OF THE INVENTION

According to an aspect of the present invention, there is provided an apparatus and method of detecting a sync signal by which an accurate sync position can be detected without satisfying a mode conversion threshold value. According to another aspect of the present invention, there is provided an apparatus reducing a symbol error rate (SER).

According to an aspect of the present invention, there is provided an apparatus detecting a sync signal, including a sync determiner selecting an output sync pattern from a candidate sync signal generated by pattern matching in lock and/or unlock modes and selecting one of candidate sync patterns of the candidate sync signal having a cycle synchronized with a sync cycle as an output sync pattern to generate an output sync signal and a mode determiner determining a mode based on the candidate sync signal, a mode conversion threshold value, and a selection number of times the candidate sync pattern is selected as the output sync pattern.

According to another aspect of the present invention, the sync determiner includes a sync generator selecting an output sync pattern from the candidate sync patterns of the candidate sync signal in the mode or interpolating a pseudo pattern to generate a generation sync signal, a cycle checker checking whether a cycle of each of the candidate sync patterns is synchronized with the sync cycle and if the cycle of the candidate sync pattern is synchronized with the sync cycle, a selector selecting the candidate sync pattern as the output sync pattern.

According to another aspect of the present invention, if it is checked that the cycle of the candidate sync pattern does not synchronize with the sync cycle, the selector selects a generation sync pattern of the generation sync signal as an output sync pattern.

According to another aspect of the present invention, the mode determiner adds the selection number to a number of times the candidate sync pattern is positioned in a window to calculate a window inclusion number, compares the window inclusion number with an unlock mode conversion threshold value to convert the lock mode into the unlock mode, and compares the window inclusion number with a lock mode conversion threshold value to convert the unlock mode into the lock mode.

According to another aspect of the present invention, there is provided a method of detecting a sync signal, including selecting an output sync pattern from a candidate sync signal generated by pattern matching in lock and/or unlock modes and selecting one of candidate sync patterns of the candidate sync signal having a cycle synchronized with a sync cycle as an output sync pattern to generate an output sync signal and determining a mode based on the candidate sync signal, a mode conversion threshold value, and a selection number of times the candidate sync pattern is selected as the output sync pattern.

According to another aspect of the present invention, the generation of the output sync signal includes selecting an output sync pattern from the candidate sync patterns of the candidate sync signal in the mode or interpolating a pseudo pattern to generate a generation sync signal, checking whether a cycle of each of the candidate sync patterns synchronizes with the sync cycle and if the cycle of the candidate sync pattern synchronizes with the sync cycle, selecting the candidate sync pattern as an output sync pattern.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional sync detecting apparatus;

FIGS. 2A-2E illustrate a clock diagram of the operation of the sync determiner 120.

FIG. 3 is a block diagram of a sync detecting apparatus according to an embodiment of the present invention;

FIG. 4 is a block diagram of a sync determiner 320 according to an embodiment of the present invention;

FIG. 5A-5E illustrate a clock diagram of an operation of the sync determiner 320 shown in FIG. 3;

FIGS. 6A-6E are views comparing an output sync signal according to an aspect of the present invention with an output sync signal according to the prior art; and

FIG. 7 is a flowchart of a method of detecting a sync signal according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

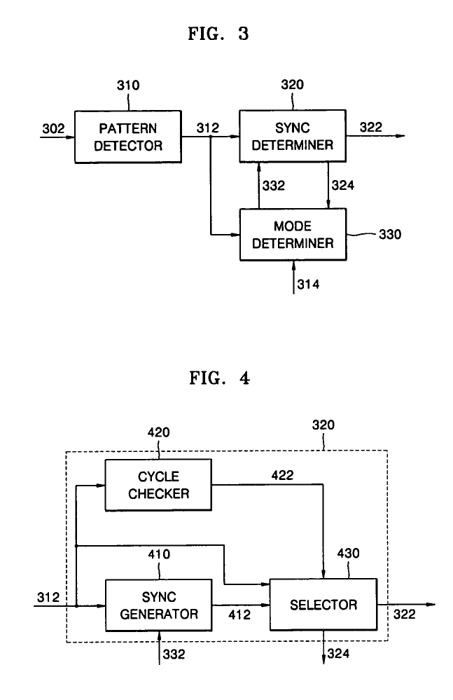

FIG. 3 is a block diagram of a sync detecting apparatus according to an embodiment of the present invention. Referring to FIG. 3, a sync detecting apparatus 300 includes a pattern detector 310, a sync determiner 320, and a mode determiner 330.

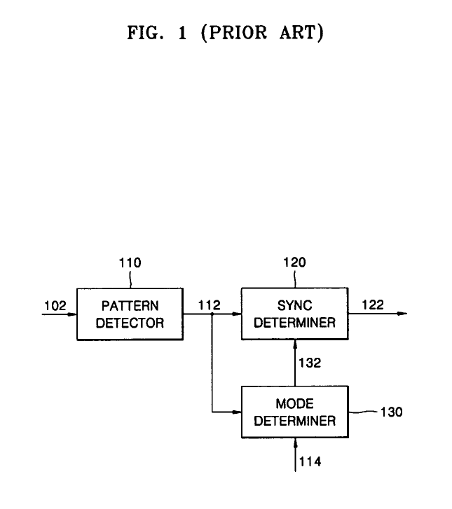

The pattern detector 310 performs pattern matching on an input signal 302 to detect a candidate sync signal 312. The pattern detector 310 is the same as the pattern detector 110 shown in FIG. 1 in that the pattern matching may be full pattern matching, common pattern matching, or margin pattern matching.

The sync determiner 320 selects an output sync pattern in lock and/or unlock modes and selects one of the candidate sync patterns of a candidate sync signal, having an interval synchronized with a sync cycle, as an output sync pattern to generate an output sync signal. Here, a number of times the candidate sync pattern, having the interval synchronized with the sync cycle, is referred to as a selection number 324 and the sync determiner 320 transmits the selection number 324 to the mode determiner 330.

The mode determiner 330 generates a mode indication signal 332 based on the candidate sync signal 312, a mode conversion threshold value 314, and the selection number 324. The selection number 324 indicates the number of times the sync determiner 320 selects the candidate sync pattern having the interval synchronized with the sync cycle as the output sync pattern.

The mode determiner 330 generates the mode indication signal 332 using the following method.

The mode determiner 330 calculates a window inclusion number Nw. Differently from the conventional mode determination method, the window inclusion number Nw=a number of times, Nw1, the candidate sync pattern of the candidate sync signal 312 is positioned in the window+the selection number Nw2.

As in the conventional mode determination method, if the window inclusion number Nw is greater than or equal to an unlock mode conversion threshold value N_ul in the lock mode, the mode determiner 330 generates a mode indication signal indicating the unlock mode.

If the window inclusion number Nw is greater than or equal to a lock mode conversion threshold value N_l in the unlock mode, the mode determiner 330 generates a mode indication signal indicating the lock mode.

FIG. 4 is a block diagram of the sync determiner 320 according to an embodiment of the present invention. Referring to FIG. 4, the sync determiner 320 includes a sync generator 410, a cycle checker 420, and a selector 430.

The sync generator 410 performs the same operation as the sync determiner 120 shown in FIG. 1. In other words, the sync generator 410 selects one of the candidate sync patterns of the candidate sync signal 312 in a detection mode indicated by the mode indication signal 332, i.e., in the lock and/or unlock modes, or interpolates a pseudo pattern to generate a generation sync signal 412.

A window position ranges from a time position of a just previous output sync pattern of an output sync signal 322 to a time position after a predetermined sync cycle (588T, 1488T, 1116T, or 1932T in cases of a CD, a DVD, a HD, and a BD, respectively). For example, a time position of a fourth output sync pattern+1488T=a window position corresponding to a fifth output sync pattern. A size of a window is selected by a user. The window is generated in each pattern and used by the sync determiner 320 and the mode determiner 330. The generation of the window is not shown in the drawings.

The cycle checker 420 checks whether a cycle of each candidate sync pattern of the candidate sync signal 312 synchronizes with a sync cycle (588T or 1488T) to generate a check signal 422. For example, if the cycle checker 420 senses that the fourth candidate sync pattern is generated, 1448T elapses, and the fifth candidate sync pattern is generated, the cycle checker 420 generates a synchronization signal indicating that a cycle of the fifth candidate sync pattern synchronizes with the sync cycle and transmits the synchronization signal to the selector 430.

If the check signal 422 is the synchronization signal, the selector 430 selects a corresponding candidate sync pattern of the candidate sync signal 312 as an output sync pattern. If the check signal 422 is a non-synchronization signal, the selector 430 selects a corresponding generation sync pattern of the generation sync signal 412 as an output sync pattern to generate the output sync signal 322.

If the selector 430 selects a candidate sync pattern as an output sync pattern, the selector 430 calculates a number of times the candidate sync pattern is selected as an output sync pattern to generate the selection number Nw2.

For example, if the check signal 422 is the synchronization signal, the selector 430 selects a fourth candidate sync pattern as the fourth output sync pattern. If the check signal 422 is the non-synchronization signal, the selector 430 selects a generation sync pattern of a generation sync signal as an output sync pattern. Here, if a candidate sync pattern is selected as an output sync pattern, the selection number Nw2 increases by “1.”

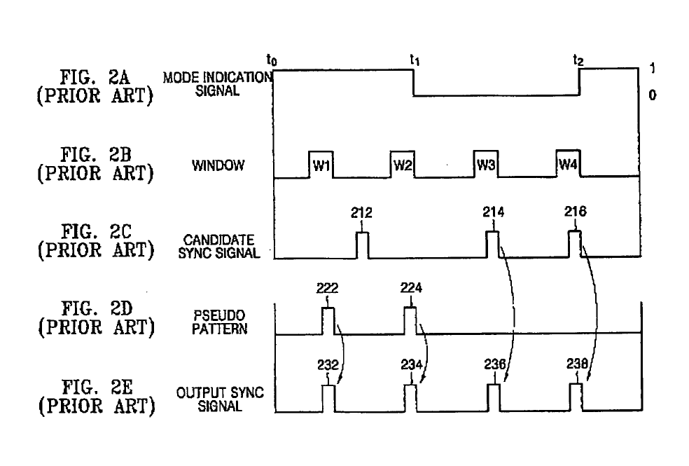

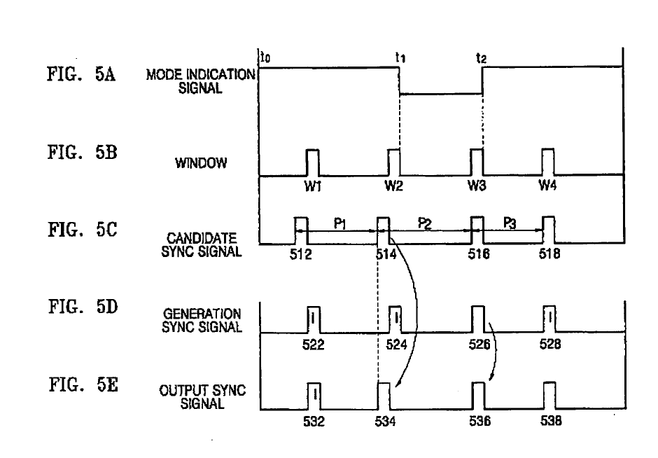

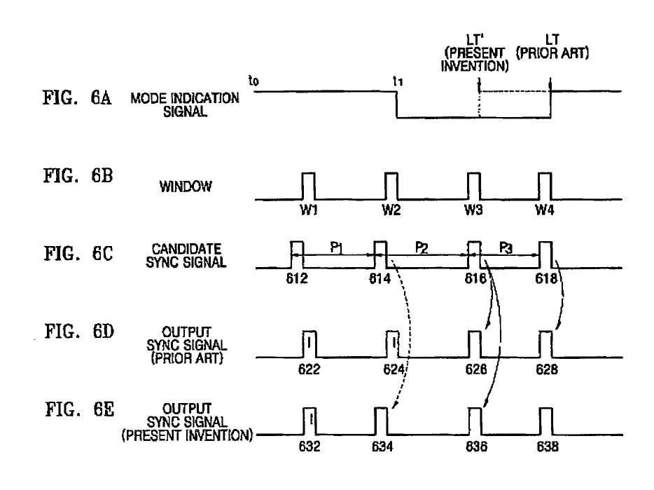

FIGS. 5A-5E are clock diagrams illustrating the operation of the sync determiner 320, where it is assumed that the unlock mode conversion threshold value N_ul is “2,” the lock mode conversion threshold value N_l is “2,” and that the mode indication signal is “1” in the lock mode and “0” in the unlock mode. As described with reference to FIG. 2, time positions of a mode indication signal, a window signal, and a candidate sync signal synchronize with one another. Also, time positions between a pseudo pattern and an output sync signal synchronize with each other. However, the time positions of the mode indication signal, the window signal, and the candidate sync signal do not synchronize with the time positions of the pseudo pattern and the output sync signal. Character “I” shown in FIGS. 5D and 5E denote an interpolated pseudo pattern.

Since no candidate sync pattern is generated (in the lock mode) in a window W1 in a section between t₀ and t₁, the sync generator 410 interpolates a pseudo pattern in a time position corresponding to the window W1 to generate a generation sync pattern 522.

The cycle checker 420 checks whether a cycle of a candidate sync pattern 512, i.e., a time interval (not shown) between the candidate sync pattern 512 and a just previous candidate sync pattern, synchronizes with a sync cycle P. In FIG. 5A, it is assumed that the cycle of the candidate sync pattern 512, i.e., the time interval between the candidate sync pattern 512 and the just previous candidate sync pattern, does not synchronize with the sync cycle P.

Accordingly, the selector 430 selects not the candidate sync pattern 512 but the generation sync pattern 522 (FIG. 5D) as an output sync pattern 532 (FIG. 5E). Here, since the candidate sync pattern 512 is not selected as an output sync pattern, the selection number Nw2 is “0.”

Since no candidate sync pattern is generated in a window W2, the sync generator 410 interpolates a pseudo pattern in a time position corresponding to the window W2 to generate a generation sync pattern 524.

The cycle checker 420 checks whether a cycle of a candidate sync pattern 514, i.e., a time interval P1 between the candidate sync pattern 514 and the candidate sync pattern 512, synchronizes with the sync cycle P. Here, it is supposed that P1=P.

Therefore, the selector 430 selects not the generation sync pattern 524 but the candidate sync pattern 514 as an output sync pattern 534 (refer to a left arrow shown in FIG. 5E). Here, since the candidate sync pattern 514 is selected as an output sync pattern, the selection number Nw2 increases by “1.” Thus, Nw2=1.

Since the window inclusion number Nw is “2” (≧the unlock mode conversion threshold value N_ul) at the time t₁, the lock mode is converted into the unlock mode.

The sync generator 410 generates an output sync signal in a section between times t₀ and t₂ in the unlock mode. In other words, the sync generator 410 selects a candidate sync pattern 516 as a generation sync pattern 526.

The cycle checker 420 checks whether a cycle of a candidate sync pattern 516, i.e., a time interval P2 between the candidate sync pattern 516 and the candidate sync pattern 514, synchronizes with the sync cycle P. Here, it is supposed that P2≠P.

Accordingly, the selector 430 selects not the candidate sync pattern 516 but the generation sync pattern 526 as an output sync pattern 536 (refer to a right arrow shown in FIG. 5E). Also, since the candidate sync patter 516 is not selected as an output sync pattern, the selection number Nw2 is kept at “1.”

At the time t₂, the window inclusion number Nw=a number of times, Nw1, a candidate sync pattern of a candidate sync signal is positioned in a window+the selection number Nw2 (=1)=2. In other words, the window inclusion number Nw is greater than or equal to the lock mode conversion threshold value N_l (=2). Thus, the unlock mode is converged into the lock mode.

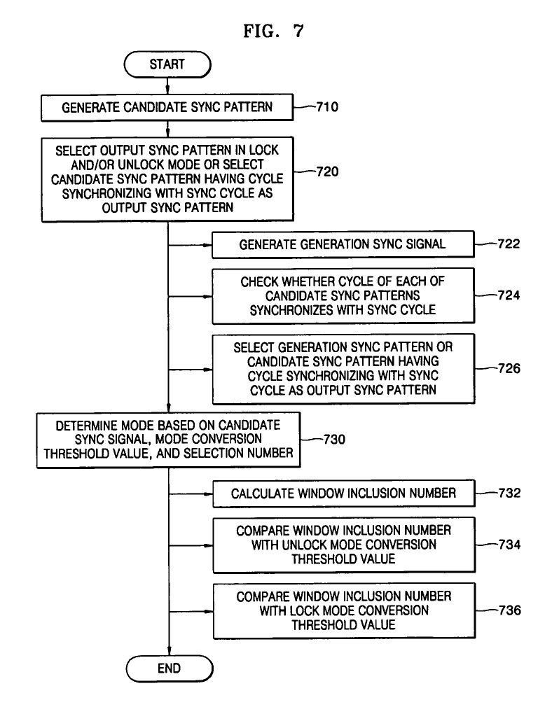

FIGS. 6A-6E are views comparing an output sync signal according to the present invention with an output sync signal according to the prior art.

A window and a candidate sync signal shown in FIGS. 6B and 6C are the same as those shown in FIGS. 5B and 5C. Thus, an output sync signal shown in FIG. 6E is also the same as that shown in FIG. 5E.

The process of generating an output sync signal according to the prior art is previously described with reference to FIG. 2. Differences between the process of generating the output sync signal according to the prior art and a process of generating an output sync signal according to the present invention will now be described.

In an aspect of the present invention, a candidate sync pattern 614 (FIG. 6C) is selected as an output sync pattern 634 (FIG. 6E) to generate a second output sync pattern. However, in the prior art, a pseudo pattern I is interpolated to generate an output sync pattern 624 (FIG. 6D).

In the prior art, the window inclusion number Nw=the number of times, Nw1, the candidate sync pattern of the candidate sync signal is positioned in the window. However, in the present invention, the window inclusion number Nw=the number of times, Nw1, the candidate sync pattern of the candidate sync signal is positioned in the window+the selection number Nw2.

According to the above-described two differences, in the prior art, the unlock mode is converted into the lock mode at a time LT. However, in an aspect of the present invention, the unlock mode is converted into the lock mode at a time LT′. This is because the window inclusion number Nw=2 at the time LT in the prior art but the window inclusion number Nw=2 at the time LT′ in the present invention. In the present invention, since the selection number Nw2=1 at the time LT′, the window inclusion number Nw=2 at the time LT′. Also, since the candidate sync pattern 614 is selected as the output sync pattern 634, the selection number Nw2=1.

As described above, in the present invention, a time when the unlock mode is converted into the lock mode, i.e., a lock time, is improved.

FIG. 7 is a flowchart of a method of detecting a sync signal according to an embodiment of the present invention.

In operation 710, pattern matching is performed on a binary signal read from a recording medium to generate a candidate sync pattern. The pattern matching may be full pattern matching, common pattern matching, or margin pattern matching.

In operation 720, an output sync pattern is selected from a candidate sync signal generated by the pattern matching in lock and/or unlock modes and one of candidate sync patterns of the candidate sync signal having a cycle synchronizing with a sync cycle is selected as an output sync pattern to generate an output sync signal. Operation 720 includes operations 722, 724, and 726.

In operation 722, an output sync pattern is selected from candidate sync patterns of the candidate sync signal or a pseudo pattern is interpolated in the lock and/or unlock modes to generate a generation sync signal.

In operation 724, it is checked whether a cycle of each of the candidate sync patterns synchronizes with the sync cycle.

If the cycle of each of the candidate sync patterns synchronizes with the sync cycle, in operation 726, the candidate sync pattern having the cycle synchronized with the sync cycle is selected as an output sync pattern. If the cycle of each of the candidate sync patterns does not synchronize with the sync cycle, in operation 726, a generation sync pattern of the generation sync signal is selected as an output sync pattern.

In operation 730, a mode is determined based on the candidate sync signal, a mode conversion threshold value, and a selection number. The selection number indicates a number of times the candidate sync pattern having the cycle synchronized with the sync cycle is selected as an output sync pattern. Operation 730 includes operation 732, 734, and 736.

In operation 732, a window inclusion number is calculated by adding the selection number to a number of times a candidate sync pattern is positioned in a window. The number of times the candidate sync pattern is positioned in the window may be obtained by checking the candidate sync signal.

In operation 734, the window inclusion number is compared with a unlock mode conversion threshold value to convert the lock mode into the unlock mode.

In operation 736, the window inclusion number is compared with a lock mode conversion threshold value to convert the unlock mode into the lock mode.

As described above, in an apparatus and method of detecting a sync signal according to an aspect of the present invention, a candidate sync pattern having a cycle synchronized with a sync cycle can be selected as an output sync pattern. A mode can be determined based on a selection number. Thus, a lock conversion time is improved. As a result, an accurate sync signal can be tracked quickly.

Also, the candidate sync pattern having the cycle synchronized with the sync cycle can be used as an output sync pattern. Thus, an SER can be reduced during modulation of data.

The method of detecting a sync signal according to an aspect of the present invention can be written as a computer program. Codes and code segments of the computer program can be easily developed by computer programmers skilled in the art. The computer program can be stored in computer-readable media, and read and executed by a computer so as to embody a sync detecting method. Examples of the compute-readable media include magnetic recording media, optical recording media, and carrier waves.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for detecting a sync signal, comprising:
a sync determiner selecting an output sync pattern from a candidate sync signal generated by pattern matching in lock and/or unlock modes and selecting one of candidate sync patterns of the candidate sync signal having a cycle synchronizing with a sync cycle as the output sync pattern to generate an output sync signal; and
a mode determiner determining the lock and/or unlock modes based on the candidate sync signal, a mode conversion threshold value, and a selection number of times the one of the candidate sync patterns is selected as the output sync pattern.

2. The apparatus of claim 1, wherein the sync determiner comprises:
a sync generator selecting the output sync pattern from the one of the candidate sync patterns of the candidate sync signal in the lock and/or unlock modes based on the candidate sync signal or interpolating a pseudo pattern to generate a generation sync signal;
a cycle checker checking whether a cycle of each of the candidate sync patterns synchronizes with the sync cycle; and
a selector selecting the one of the candidate sync patterns as the output sync pattern if the cycle of the one of the candidate sync patterns synchronizes with the sync cycle.

3. The apparatus of claim 2, wherein if the cycle of the one of the candidate sync patterns does not synchronize with the sync cycle, the selector selects a generation sync pattern of the generation sync signal as the output sync pattern.

4. The apparatus of claim 1, wherein the mode determiner adds the selection number to a number of times the one of the candidate sync patterns is positioned in a window to calculate a window inclusion number, compares the window inclusion number with a unlock mode conversion threshold value to convert the lock mode into the unlock mode, and compares the window inclusion number with a lock mode conversion threshold value to convert the unlock mode into the lock mode.

5. The apparatus of claim 1, further comprising:
a pattern detector performing the pattern matching on a binary signal read from a recording medium to generate the candidate sync patterns.

6. The apparatus of claim 5, wherein the pattern detector performs the pattern matching using one of full pattern matching, common pattern matching, or margin pattern matching.

7. The apparatus of claim 1, wherein the sync cycle is one of 588T, 1488T, 1116T, or 1932T.

8. A method of detecting a sync signal, comprising:
selecting an output sync pattern from a candidate sync signal generated by pattern matching in lock and/or unlock modes and selecting one of candidate sync patterns of the candidate sync signal having a cycle synchronizing with a sync cycle as the output sync pattern to generate an output sync signal; and
determining the lock and/or unlock modes based on the candidate sync signal, a mode conversion threshold value, and a selection number of times the one of the candidate sync patterns is selected as the output sync pattern.

9. The method of claim 8, wherein the generation of the output sync signal comprises:
selecting the output sync pattern from the one of the candidate sync patterns of the candidate sync signal in the lock and/or unlock modes based on the candidate sync signal or interpolating a pseudo pattern to generate a generation sync signal;
checking whether a cycle of each of the candidate sync patterns synchronizes with the sync cycle; and
if the cycle of the one of the candidate sync patterns synchronizes with the sync cycle, selecting the one of the candidate sync patterns as the output sync pattern.

10. The method of claim 9, wherein if the cycle of the one of the candidate sync patterns does not synchronize with the sync cycle, a generation sync pattern of the generation sync signal is selected as the output sync pattern.

11. The method of claim 8, wherein the determination of the lock and/or unlock modes comprises:
adding the selection number of the times the candidate sync pattern is selected as the output sync pattern to a number of times the one of the candidate sync patterns is positioned in a window to calculate a window inclusion number;
comparing the window inclusion number with a unlock mode conversion threshold value to convert the lock mode into the unlock mode; and
comparing the window inclusion number with a lock mode conversion threshold value to convert the unlock mode into the lock mode.

12. The method of claim 8, further comprising:
performing the pattern matching on a binary signal read from a recording medium to generate the candidate sync patterns.

13. The method of claim 12, wherein the pattern matching is one of full pattern matching, common pattern matching, or margin pattern matching.

14. A computer-readable recording medium having embodied thereon a computer program for implementing the method of claim 8.

15. The apparatus of claim 4, wherein a position of the window ranges from a time position of a previous output sync pattern of the output sync signal to a time position after a predetermined sync cycle.

16. The apparatus of claim 2, further comprising:
a selector, wherein if a check signal generated by the cycle checker is a synchronization signal, the selector selects a corresponding candidate sync pattern of the candidate sync signal as the output sync pattern and if the check signal is a non-synchronization signal, the selector selects a corresponding generation sync pattern of the generation sync signal as the output sync pattern to generate the output sync signal.

17. The apparatus of claim 16, wherein if the selector selects the one of the candidate sync patterns as the output sync pattern, the selector calculates the number of times the one of the candidate sync patterns is selected as the output sync pattern to generate the selection number.

18. The apparatus of claim 4, wherein the window inclusion number includes the number of times the candidate sync pattern of the candidate sync signal is positioned in the window and the selection number of the times the one of the candidate sync patterns is selected as the output sync pattern.

19. The method of claim 11, wherein a position of the window ranges from a time position of a previous output sync pattern of the output sync signal to a time position after a predetermined sync cycle.

20. The method of claim 9, wherein if the a signal is a synchronization signal, selecting a corresponding candidate sync pattern of the candidate sync signal as the output sync pattern and if the check signal is a non-synchronization signal, selecting a corresponding generation sync pattern of the generation sync signal as the output sync pattern to generate the output sync signal.

21. The method of claim 20, wherein if the one of the candidate sync patterns is selected as the output sync pattern, calculating the number of times the one of the candidate sync patterns is selected as the output sync pattern to generate the selection number.

22. An apparatus detecting a sync signal, comprising:
a sync determiner selecting a candidate sync pattern having a cycle synchronized with a sync cycle as an output sync pattern to generate an output sync signal; and
a mode determiner determining lock and/or unlock modes based on a selection number of times the candidate sync pattern is selected as the output sync pattern.

23. The apparatus of claim 22, wherein the candidate sync pattern is selected as the output sync pattern to generate a second output sync pattern.
